(19) United States
(12) Patent Application Publication
(10) Pub. No.: US 2006/0147781 A1
(43) Pub. Date: Jul. 6, 2006

(54) Fuel cell collector plates containing grafted polyolefins

(76) Inventors: Yuqi Cai, Kingston (CA); Sassan Hojabr, Kingston (CA); John Charles Fisher, Kingston (CA)

Correspondence Address: Thomas W Gorman;E I du Pont de Nemours & Company, Legal Patents, Wilmington, DE, 19898, US

(21) Appl. No.: 10/562,480

(22) PCT Filed: Apr. 4, 2004
(86) PCT No.: PCT/CA04/00976

§ 371 Date: Dec. 22, 2005

Related U.S. Application Data
(60) Provisional application No. 60/484,441, filed on Jul. 2, 2003.

(51) Int. Cl. H01M 8/02; H01B 1/24; C08J 5/00

(52) U.S. Cl. 429/34; 252/511; 264/331.11

(57) ABSTRACT

A conductive composition for fuel cell collector plates and the molding methods thereof are provided. The molding composition includes a polymer resin and conductive fillers, wherein the polymer resin is a polymer blend comprising (1) from about 10 to 100 wt %, preferably from about 50 to about 100 wt % of a grafted polyolefin or a blend of grafted polyolefins and (2) from 0 to about 90 wt %, preferably from about 0 to about 50 wt % of at least one other thermoplastic polymer having a melting point below 280° C. One type of or a combination of different types of highly conductive fillers are selected from carbon, graphite, metallic fillers and mixtures thereof. The polymer resin and conductive fillers are blended into a homogeneous mixture and molded into a collector plate. A preferred method of injection molding and a preferred method of injection-compression molding are provided to mold the composition into the shape of a fuel cell collector plate having a volume resistivity of not more than about 0.1 ohm.cm. The collector plate is particularly suitable for, but not limited to, use in polymer electrolyte membrane fuel cells.

### FIELD OF THE INVENTION

This invention relates to conductive flow field separator plates for fuel cells, and to methods for making such plates. The plates comprise a mixture of a polymer resin and conductive fillers, wherein the polymer resin is selected from a grafted polyolefin, a blend of grafted polyolefins and a blend of a grafted polyolefin and at least one other thermoplastic polymer having a melting point below 280° C.

### BACKGROUND OF THE INVENTION

With the fast rising global demand for cheap and clean power, the development of polymer electrolyte membrane fuel cells has accelerated greatly. A typical single solid polymer electrolyte membrane fuel cell of the prior art is shown in FIG. 1. The fuel cell comprises an anode current collector plate 1, an anode-backing layer 2, an anode catalyst layer 3, a polymer electrolyte membrane 4, a cathode catalyst layer 5, a cathode-backing layer 6 and a cathode current collector plate 7. Individual fuel cells may be connected in series to form a fuel cell stack.

Current collector plates, also called flow field plates or separator plates, perform the functions of connecting individual cells, collecting cell current generated within the cells, accommodating or distributing cell reactants, removing cell reaction products and assisting with thermal control. To meet these requirements, the collector, plates must have excellent electrical conductivity, good mechanical strength, sufficient chemical stability and low gas permeability. As well, the materials used to make the plates, and their method of manufacture, must have a low cost to allow the plates to be commercially viable.

A typical collector plate requires flow field channels 8, 9 in FIG. 1 on its surfaces to direct fuel reactants or oxygen, and reaction by-products such as water. Graphite plates with machined flow fields have historically been used as collector plates for fuel cells. Due to their brittleness and high fabrication/machining cost, graphite plates are relatively expensive to make such that they cannot meet the requirements for large-scale commercialization of fuel cells.

Recently, substantial efforts have been focused on making collector plates by molding of thermoplastic conductive polymer compositions. These plates can have flow-field channels molded directly onto their surfaces without having to post-machine the flow fields. Some of these efforts are described in published PCT patent application nos. WO99/49530, WO00/30202, WO00/30203 and WO00/44005. Polyphenylene ether, polyphenylene sulfide, modified polyphenylene oxide, and liquid crystal polymer have been used as the preferred resins for making the collector plates by molding. These compositions, however, can have significant disadvantages, including:
a. All these resins are very expensive. Their use therefore results in higher costs for collector plates and fuel cell units.
b. All these resins require high melt processing temperature (above 280° C.) and high mold temperature (above 100° C.) during the manufacturing process of the collector plates. A very long heating/cooling cycle, high energy consumption and high machinery cost become the major hurdles for cost reduction in the commercial manufacturing process of these collector plates.

U.S. Pat. No. 6,511,768 discloses the use of a polypropylene-based conductive porous matrix for fabricating electrode materials. U.S. Pat. No. 5,804,116 discloses plates comprising polypropylene that have good thermal conductivity, but no mention is made of their electrical conductivity.

Thus, there is a need for developing a relatively low cost and highly conductive composition that has low melt viscosity or good moldability and can be easily processed below a temperature of 280° C. and is suitable for application as fuel cell collector plates.

It is therefore one aspect of the present invention to provide a low cost and highly conductive polymer composition comprising an inexpensive polymer material and conductive fillers. The composition preferably has low melt viscosity, good moldability and provides excellent electrical conductivity and sufficient mechanical strength after being molded into collector plates for use in fuel cells.

It is another aspect of the present invention to provide a method of preparing the composition and of molding the composition into collector plates using a fast molding process.

The disclosures of all patents/applications referenced herein are incorporated herein by reference.

### SUMMARY OF THE INVENTION

In accordance with one aspect of the present invention, there is provided an electrically conductive shaped article comprising a polymer resin and conductive fillers, wherein the polymer resin is a polymer blend comprising (1) from about 10 to 100 wt %, preferably from about 50 to about 100 wt % of a grafted polyolefin or a blend of grafted polyolefins and (2) from 0 to about 90 wt %, preferably from about 0 to about 50 wt % of at least one other thermoplastic polymer having a melting point below 280° C.

In accordance with a second aspect of the present invention, there is provided a conductive flow field separator plate for use in a polymer electrolyte membrane fuel cell comprising a polymer resin and conductive fillers, wherein the polymer resin is a polymer blend comprising (1) from about 10 to 100 wt %, preferably from about 50 to about 100 wt % of a grafted polyolefin or a blend of grafted polyolefins and (2) from 0 to about 90 wt %, preferably from about 0 to about 50 wt % of at least one other thermoplastic polymer having a melting point below 280° C.

In accordance with a further aspect of the present invention, there is provided a method of making a conductive flow field separator plate comprising the steps of:
(a) mixing a polymer resin with conductive fillers to form a conductive blend, wherein the polymer resin is a polymer blend comprising (1) from about 10 to 100 wt %, preferably from about 50 to about 100 wt % of a grafted polyolefin or a blend of grafted polyolefins and (2) from 0 to about 90 wt %, preferably from about 0 to about 50 wt % of at least one other thermoplastic polymer having a melting point below 280° C.; and
(b) molding the conductive blend to form the conductive flow field separator plate.

In yet a further aspect of the present invention, there is provided a process for making a conductive flow field separator plate for use in polymer electrolyte membrane fuel cells comprising the steps of:
(a) feeding a mixture of a polymer resin and conductive fillers into an injection molding machine, wherein the polymer resin is a polymer blend comprising (1) from about 10 to 100 wt %, preferably from about 50 to about 100 wt % of a grafted polyolefin or a blend of grafted polyolefins and (2) from 0 to about 90 wt %, preferably from about 0 to about 50 wt % of at least one other thermoplastic polymer having a melting point below 280° C.,
(b) plasticising the mixture at a temperature above the melting point of the polymer resin to form a melt,
(c) injecting the melt into a mold,
(d) allowing the melt to cure in the mold to form the conductive flow field separator plate, and
(e) removing the conductive flow field separator plate from the mold.

In preferred embodiments, the present invention relates to a conductive composition comprising from about 10 to about 50 wt %, preferably from about 15 to about 25 wt % of the polymer resin and from about 50 to about 90 wt %, preferably from about 75 to about 85 wt % of one type or a combination of different types of conductive fillers selected from carbon fillers, graphite fillers, metal fillers, inherently conductive polymers, and mixtures thereof.

The preferred conductive composition of the present invention may be molded to form a fuel cell collector plate by compression molding, injection molding, or injection-compression molding, extrusion, transfer molding, extrusion-transfer-pressing, calendering, laminating, coating or by other suitable molding methods. Preferably, the preferred conductive composition of the present invention is molded by injection molding or injection-compression molding to form a fuel cell collector plate. The molded fuel cell collector plate made from the preferred conductive composition has a volume resistivity (Four Point method) of not more than about 0.1 ohm.cm and a flexural strength of not less than about 3000 Psi. The molded plates are particularly suitable for use as current collector plates in solid polymer electrolyte fuel cells.

### BRIEF DESCRIPTION OF THE DRAWINGS

Embodiments of the present invention will be described with reference to the accompanying drawings in which like numerals refer to the same parts in the several views and in which:

FIG. 1: is a schematic perspective view of a typical fuel cell of the prior art.

FIG. 2: is a flow chart showing the steps in a preferred embodiment of the method of manufacturing separator plates of the present invention.

### DETAILED DESCRIPTION OF THE PREFERRED EMBODIMENTS

The preferred embodiments of the present invention will now be described with reference to the accompanying figures.

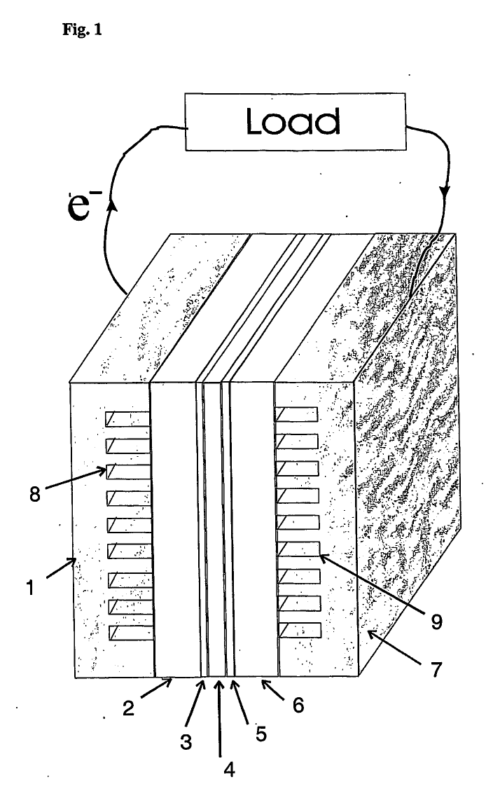

With reference to FIG. 1, there is shown in a schematic perspective view, a typical fuel cell of the prior art. This typical polymer electrolyte membrane fuel cell includes an anode current collector plate (1), an anode backing layer (2), an anode catalyst layer (3), a membrane (4), a cathode catalyst layer (5), a cathode backing layer (6), a cathode current collector plate (7), and plate flow field channels (8) and (9).

Generally, the present invention relates to a conductive composition for making current collector plates (1) and (7). Briefly, in the preferred embodiment, the conductive composition comprises a mixture of a polymer resin and conductive fillers. The total amount of the polymer resin in the composition is from about 10 to about 50 wt %, preferably from about 15 to about 25 wt %, while the total amount of the conductive fillers in the composition is from about 50 to about 90 wt %, preferably from about 15 to about 25 wt %, based on the total weight of the polymer resin/filler mixture. The polymer resin/filler mixture is mixed or compounded into a homogeneous mixture and subsequently fed into a molding machine to mold a current collector plate. The polymer resin/filler mixture is preferably prepared by dry-blending the polymer resin/filler mixture in a blender or a container at a temperature below the melting point of the polymer resin. The polymer resin/filler mixture is then fed directly into a molding machine, such as an injection molding machine or an injection-compression molding machine to mold a current collector plate having a volume resistivity of not more than 0.1 ohm.cm and a flexural strength of higher than about 3000 Psi.

The polymer resin useful in the present invention is a grafted polyolefin, a blend of grafted polyolefins or a polymer blend comprising (1) from about 10 to 100 wt %, preferably from about 50 to about 100 wt % of a grafted polyolefin or a blend of grafted polyolefins and (2) from 0 to about 90 wt %, preferably from about 0 to about 50 wt % of at least one other thermoplastic polymer having a melting point below 280° C.

Preferably, the grafted polyolefin is a low cost polymer material with high melt flow rate, such as maleic anhydride grafted polypropylene. The grafted polyolefin can be manufactured by different processes such as melt grafting, solution grafting and radiation grafting processes. Examples of grafting processes are described in GB2081723, U.S. Pat. No. 4,298,712, WO94/25498 and WO95/24449, all of which are incorporated herein by reference. The grafted polyolefins suitable for the present invention include grafted homopolymers and copolymers of unsaturated hydrocarbons having 2-20 carbon atoms. They can also be made by processes well known in the art, including polymerization processes in which metallocene catalysts are used (single site catalysts). For example, the polymers are homopolymers of ethylene or propylene or copolymers of ethylene with one or more alpha-olefin hydrocarbons having 3-10 carbon atoms, especially propylene, butene-1, hexene-1 and octene-1 and styrene. Suitable alpha-olefins also include dienes, that is, monomers with more than 1 site of unsaturation, especially 1,3 butadiene, 1,5 hexadiene, 5-ethylidene-2-norbornene and norbornadiene. In particularly preferred embodiments, the polyolefins are polypropylene homopolymers and ethylene-propylene copolymers, propylene-alpha olefin copolymers having a density in the range of about 0.850 to about 0.970 grams per cubic centimetre (g/cm³) and especially in the range of 0.860 to 0.930 g/cm³.

Still other suitable grafted polyolefins that may be used in the present invention may be ethylene/alpha olefin copolymers such as copolymers of ethylene and a vinyl alkanoate, especially ethylene/vinyl acetate copolymers. The copolymers may have a relatively high ethylene content, or lower ethylene contents. In addition, the copolymers are available in a variety of molecular weights, which is usually expressed in terms of melt index.

The grafting monomer is preferably selected from the group consisting of ethylenically unsaturated carboxylic acids and ethylenically unsaturated carboxylic acid anhydrides, including derivatives of such acids, and mixtures thereof. Examples of the acids and anhydrides, which may be mono-, di- or polycarboxylic acids, are acrylic acid, methacrylic acid, maleic acid, fumaric acid, itaconic acid, crotonic acid, itaconic anhydride, maleic anhydride and substituted maleic anhydride e.g. dimethyl maleic anhydride or citraconic anhydride, nadic anhydride, nadic methyl anhydride and tetrahydro phthalic anhydride. Most suitable ethylenically unsaturated acids or acid derivatives include for example maleic anhydride, acrylic acid, methacrylic acid and its derivatives.

The weight percentage of the monomers grafted onto the polyolefin is preferably in the range of about 0.05 wt % to about 10 wt % based on the total resin weight. The grafted polyolefin preferably has a melt flow rate (MFR) in the range of about 0.5 to about 1000 g/10 min (test standard of ASTM D-1238) and most preferably in the range of about 50 to 500 g/10 min. The melting point of the grafted polyolefin is preferably in the range of about 100 to about 280° C. (ASTM D-3418) and most preferably in the range of about 140-220° C.

The polymer resin used in the present invention can also be a blend of the above-mentioned grafted polyolefins, or a blend of the above mentioned grafted polyolefins and at least one other thermoplastic polymer having a melting point below 280° C. Examples of suitable thermoplastic polymers include polypropylene, polyethylene, modified polypropylene, modified polyethylene, nylons, polyesters, polycarbonate, polyurethane, acrylonitrile-butadiene-styrene (ABS) etc.

The conductive fillers useful with the present invention may include one or more conductive fillers selected from the following: carbon fillers, graphite fillers, metal fillers, inherently conductive polymers and a mixture thereof. The conductive fillers may be in the shape of spherical or irregular particles, fibers or flakes. The conductive filler particle size may be between about 10 and about 500 μm, and the carbon or graphite fibers preferably have a diameter of less than 15 μm and a length of less than about 10 mm.

The preferred conductive composition of the present invention comprises from about 10 wt % to about 50 wt %, preferably from about 15 wt % to about 25 wt %, of the polymer resin, and from about 50 wt % to about 90 wt %, preferably from about 75 wt % to about 85 wt %, of one type or a combination of different types of the conductive fillers.

The conductive composition of the present invention is suitable for fabricating electrically conductive shaped articles such as current collector plates used in fuel cells. These articles may be made using compression molding, injection molding or injection-compression molding, extrusion, transfer molding, extrusion-transfer-pressing, calendering, laminating, coating or by other suitable molding methods. A current collector plate made in accordance with the present invention may have flat surfaces or grooves on one or both of its surfaces, wherein the grooves define a flow-field pattern. The current collector plate preferably has a thickness ranging from about 0.5 mm to about 5 mm and a volume resistivity of not more than about 0.1 ohm.cm. The flexural strength of the current collector plates is preferably not less than about 3000 Psi.

The volume resistivity is measured using the standard four-point method, which is performed in accordance with the method described in Wieder, HH, Laboratory Notes on Electrical and Galvanomagnetic Measurements, Material Science Monograph, Vol. 2, Elsevier Pub., Amsterdam, 1979, which is herein incorporated by reference. A current (I) is injected at the first of four linear equispaced point electrode probes and collected at the fourth electrode, while the potential difference (ΔV) between the second and third electrodes is measured. The resistivity (ρ) is determined using the following equation where T is the thickness of the sample, and R is the measured resistance.
ρ=4.53 RT
The flexural strength of the plates is measured according to ASTM D-790.

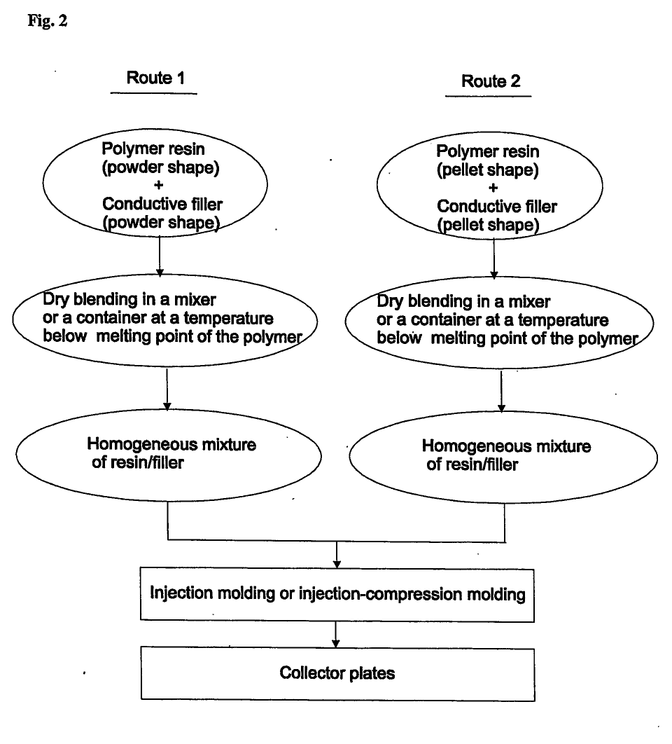

As illustrated in FIG. 2, the preferred method for making the current collector plates includes two different routes with the following steps. The polymer resin/fillers blend is prepared by dry-blending (tumbling in a container or mixing in a blender) at a temperature below the melting point of the resin. The polymer resin and fillers can be either both in powder form (Route 1) or both in pellet form (Route 2) in order to be well mixed in the composition. The polymer resin/fillers blend is then fed into the hopper of an injection molding machine or an injection-compression molding machine. The machine barrel has a temperature profile above the melting temperature of the resin. The blend is plasticized inside the machine barrel and injected into a mold. The molded article is solidified in the mold and removed after solidification.

In the case of injection-compression molding, the mold remains half open as the melt is injected into the mold cavity. Subsequently after this injection step, the mold is completely closed and compressed (compression step). A gap between the two mold halves helps reduce melt pressure drop and therefore necessitates lower injection pressure from the machine injection unit. In some cases, an injection molding machine or an injection-compression molding machine has one hopper for feeding the resin and another hopper for feeding the fillers, so that the resin and fillers can be fed separately. The fillers hopper is normally located on the barrel zone and thus fed at a point after the resin has been melted inside the barrel. This arrangement is preferred as it helps to reduce serious fiber breakage when conductive fibers are used.

Although in a preferred embodiment, the present conductive composition is molded into a current collector plate, the composition of the present invention may also be used for coating or laminating metallic plates.

The preferred conductive flow field separator plates of the present invention are useful for low temperature fuel cell applications and also for direct methanol fuel cell applications.

The following examples illustrate the various advantages of the preferred method of the present invention.

### EXAMPLES

### Example 1

400 grams of maleic anhydride grafted polypropylene powder with an average particle size of 500 μm (FUSABOND®, P series, grade M-613-05, maleic anhydride grafting level=0.5 wt %, MFR=120 g/10 min, available from DuPont Canada) and 1600 grams of graphite powder (THBERMOCARB®, grade CF-300, average particle size about 300 μm, available from CONOCO, USA) were dry-blended by tumbling mixing to form a homogeneous blend comprising 20 wt % of maleic anhydride grafted polypropylene resin and 80 wt % of the graphite filler. The mixture was injection molded into current collector plates using a 180 ton NISSEI injection molding machine (type FS180S36ASE, NISSEI, Japan) with the following processing conditions:

Screw D=56 mm, and nozzle D=5 mm.
Mold: 2 cavity plate mold with a fan gate, one 4″×4″× 1/10″ flat plate and
one 4″×4″× 1/10″ grooved plate.
Barrel temperature=150, 190, 200, 200° C.
Melt temperature=205° C.
Mold temperature=80° C.
Injection pressure=1354 kg/cm²
Back pressure=0 kg/cm²
Injection speed=11 cm/s
Screw speed=100 rpm

Under these molding conditions, both the flat plate mold and the grooved plate mold were completely filled. The molded plates were well packed without short filling problems. The average volume resistivity (using the Four Probe Method described above) of the plates was measured as 0.06 ohm.cm. The average flexural strength of the plates was measured as 4700 psi.

### Example 2

500 grams of the same maleic anhydride grafted polypropylene resin as used in Example 1, 200 grams of the same graphite powder as used in Example 1 and 1300 grams of pitch-based graphite fiber (DIALEAD® K223HG, 6 mm long pellet, available from Mitsubishi Chemical of America) were dry blended by tumbling mixing to form a homogeneous blend comprising 25 wt % of the maleic anhydride grafted polypropylene resin, 10 wt % of the graphite powder and 65 wt % of the graphite fiber. The blend was injection molded on the same machine under the same conditions as used in Example 1.

Under these molding conditions, both the flat plate mold and the grooved plate mold were completely filled. The molded plates were well packed without short filling problems. The average volume resistivity of the plates was measured as 0.1 ohm.cm. The average flexural strength is measured as 6004 psi.

### Example 3

400 grams of the same maleic anhydride grafted polypropylene as in Example 1, but in pellet form, and 1600 grams of pitch-based graphite fiber as used in Example 2 were dry blended by tumbling mixing to form a homogeneous mixture comprising 20 wt % of maleic anhydride grafted polypropylene resin, and 80 wt % of graphite fiber. The mixture was injection molded on the same machine under the same molding conditions as used in Example 1 except that a mold temperature of 120° C. was used in this example.

Under these molding conditions, both the flat plate mold and the-grooved plate mold were completely filled. The molded plates were well packed without short filling problems. The average volume resistivity of the plates was measured as 0.05 ohm.cm. The average flexural strength was measured as 3426 psi.

### Example 4

400 grams of the same maleic anhydride grafted polypropylene as used in Example 1 and 1600 grams of graphite powder (THERMOCARB®, fine grade, average particle size 50 μm, available from CONOCO, USA) were dry blended by tumbling mixing to form a homogeneous blend comprising 20 wt % of maleic anhydride grafted polypropylene resin and 80 wt % of the graphite filler. The mixture was injection molded on a 100 ton SUMITOMO® injection-compression molding machine (SH100C360, SUMITIMO, Japan) with the following processing conditions:

Screw D=36 mm, nozzle D=5 mm.
Mold: Central gated disc mold, D=15 cm, Disc thickness with gradual decrease from 3 mm in center to 1.5 mm at edge
Barrel temperature=160, 190, 200, 200° C.
Melt temperature=200° C.
Mold temperature=80° C.
Injection pressure=1100 kg/cm²
Back pressure=0 kg/cm²
Injection speed=7.5 cm/s
Screw speed=80 rpm
Compression distance=500 μm.

Under these molding conditions, the plate mold was completely filled and the molded pates were well packed without short filling problems. The average volume resistivity of the plates was measured as 0.06 ohm.cm. The average flexural strength was measured as 4810 psi.

### Comparative Example A

400 grams of ground polypropylene homopolymer resin (AMOCO® 1246, MFR=20 g/10 min, average particle size of 500 μm) and 1600 grams of the same graphite powder as used in Example 1 were dry blended by tumbling mixing to form a homogeneous blend comprising 20 wt % of the polypropylene resin and 80 wt % of the graphite filler. The blend was injection molded into collector plates under same conditions as used in Example 1.

Under these conditions, the flat plate was reluctantly filled with serious melt flow difficulty. The plate mold with grooves was just partially filled even when using a maximal injection pressure of 1368 kg/cm². The average volume resistivity of the plates was measured as 0.13 ohm.cm. The average flexural strength was measured as 3353 psi.

### Comparative Example 2

300 grams of ground polypropylene homopolymer resin (NOVOLEN®, MFR=120 g/10 min, average particle size of 500 μm) and 1200 grams of the same graphite powder as used in Example 1 were dry blended by tumbling mixing to form a homogeneous blend comprising 20 wt % of the polypropylene resin and 80 wt % of the graphite filler. The blend was injection molded into collector plates under the same conditions used in Example 1.

With these conditions, neither the flat plate nor the grooved one was filled due to serious melt flow difficulty. The volume resistivity of the plates was measured as 0.2 ohm.cm. There was no sufficient sample size available for flexural strength test.

Although the present invention has been shown and described with respect to its preferred embodiments and in the examples, it will be understood by those skilled in the art that other changes, modifications, additions and omissions may be made without departing from the substance and the scope of the present invention as defined by the attached claims.

1-30. (canceled)

31. An electrically conductive shaped article comprising a polymer resin and conductive fillers, wherein the polymer resin is a polymer blend comprising (1) from about 10 to 10 wt % of a grafted polyolefin or a blend of grafted polyolefins and (2) from 0 to about 90 wt % of at least one other thermo plastic polymer having a melting point below 280° C.

32. The electrically conductive shaped article of claim 31 wherein the polymer blend comprises from 50 to 100 wt % of a grafted polyolefin or a blend of grafted polyolefins, and from 0 to 50 wt % of at least one thermoplastic polymer having a melting point below 280° C.

33. The electrically conductive shaped article of claim 31, wherein the grafted polyolefin is a grafted polypropylene.

34. The electrically conductive shaped article of claim 33, wherein the grafted polypropylene is maleic anhydride grafted polypropylene.

35. The electrically conductive shaped article of claim 31, wherein the grafted polyolefin contains from about 0.05 wt % to about 10 wt % of ethylenically unsaturated carboxylic acid or its derivatives grafted onto the grafted polyolefin.

36. The electrically conductive shaped article of claim 35 wherein the grafted polyolefin contains from 0.05 to 5 wt % of ethylenically unsaturated carboxylic acid or its derivatives grafted onto the grafted polyolefin.

37. The electrically conductive shaped article of any one of claim 31 comprising from about 10 wt % to about 50 wt % of the polymer resin and from about 50 wt % to about 90 wt % of the conductive fillers.

38. The electrically conductive shaped article of claim 33, wherein the grafted polypropylene comprises a grafted polypropylene homopolymer, grafted propylene copolymers or mixtures thereof.

39. The electrically conductive shaped article of claim 31, wherein the conductive fillers are selected from carbon fillers, graphite fillers, metallic fillers, inherent conductive polymers and mixtures thereof, and the conductive fillers are in the shape of spherical or irregular particles, fibers, powders, flakes or a mixture thereof.

40. A conductive flow field separator plate for use in a polymer electrolyte membrane fuel cell comprising the electrically conductive shaped article of claim 31.

41. The conductive flow field separator plate of claim 40, wherein the grafted polyolefin contains from about 0.05 wt % to about 10 wt % of ethylenically unsaturated carboxylic acid or its derivatives grafted onto the grafted polyolefin.

42. The conductive flow field separator plate of claim 40, wherein the grafted polyolefin is maleic anhydride grafted polypropylene.

43. The conductive flow field separator plate of claim 40 comprising from about 10 wt % to about 50 wt % of the polymer resin and from about 50 wt % to about 90 wt % of the conductive fillers.

44. The conductive flow field separator plate of claim 42, wherein the maleic anhydride grafted polypropylene has a resin base of polypropylene homopolymer, a copolymer of propylene with other olefinic monomers or a mixture thereof.

45. The conductive flow field separator plate of claim 40 wherein the conductive fillers are selected from carbon fillers, graphite fillers, metallic fillers, inherent conductive polymers and mixtures thereof, and the conductive fillers are in the shape of spherical or irregular particles, fibers, powders, flakes or a mixture thereof.

46. The conductive flow field separator plate of claim 42, having a volume resistivity of not more than about 0.1 ohm.cm and a flexural strength of not less than about 3000 Psi.

47. A method of making a conductive flow field separator plate comprising the steps of:
(a) mixing a polymer resin with conductive fillers to form a conductive blend, wherein the polymer resin is a polymer blend comprising (1) from about 10 to 100 wt % of a grafted polyolefin or a blend of grafted polyolefins and (2) from 0 to about 90 wt % of at least one other thermoplastic polymer having a melting point below 280° C.; and
(b) molding the conductive blend to form the conductive flow field separator plate.

48. The method of claim 47, wherein the grafted polyolefin comprises from about 0.05 wt % to about 10 wt % of ethylenically unsaturated carboxylic acid or its derivatives grafted onto the grafted polyolefin.

49. The method of claim 47, wherein the grafted polyolefin is maleic anhydride grafted polypropylene.

50. The method of any one of claims 47, comprising from about 10 wt % to about 50 wt %, of the polymer resin and from about 50 wt % to about 90 wt %, of the conductive fillers.

51. The method of claim 49, wherein the grafted polyolefin has a resin base of a polypropylene homopolymer, a copolymer of propylene with other olefinic monomers or a mixture thereof.

52. The method of claim 47, wherein the conductive fillers are selected from carbon fillers, graphite fillers, metallic fillers, inherent conductive polymers and mixtures thereof, and the conductive fillers are in the shape of spherical or irregular particles, fibers, powders, flakes or a mixture thereof.

53. The method of claim 47, wherein the separator plate has a volume resistivity of not more than about 0.1 ohm.cm and a flexural strength of not less than about 3000 Psi.

54. A process for making a conductive flow field separator plate for use in polymer electrolyte membrane fuel cells comprising the steps of:
(a) feeding a mixture of a polymer resin and conductive fillers into an injection molding machine, wherein the polymer resin is a polymer blend comprising (1) from about 10 to 100 wt % of a grafted polyolefin or a blend of grafted polyolefins and (2) from 0 to about 90 wt % of at least one other thermoplastic polymer having a melting point below 280° C.,
(b) plasticising the mixture at a temperature above the melting point of the polymer resin to form a melt,
(c) injecting the melt into a mold,
(d) allowing the melt to cure in the mold to form the conductive flow field separator plate, and
(e) removing the conductive flow field separator plate from the mold.

55. The process of claim 54, wherein in step (c), the mold is closed.

56. The process of claim 54, wherein in step (c), the mold is partially opened, and comprising the further step of closing the mold completely and then compressing the melt.
